(19) United States
(12) Patent Application Publication
(10) Pub. No.: US 2012/0253843 A1
(43) Pub. Date: Oct. 4, 2012

(54) METHODS, APPARATUSES, AND COMPUTER PROGRAM PRODUCTS FOR FACILITATING MEDICAL CASE CHARTING

(75) Inventor: Evan Schnell, O'Hara Township, PA (US)

(73) Assignee: McKesson Financial Holdings Limited

(21) Appl. No.: 13/075,308

(22) Filed: Mar. 30, 2011

(51) Int. Cl. G06Q 50/00

(52) U.S. Cl. 705/3

(57) ABSTRACT

Methods, apparatuses, and computer program products are provided for facilitating medical case charting. A method may include causing presentation of one or more default value options for a case being charted. The default value options may have been captured from data charted in one or more previously charted cases. The method may further include determining a selection of one or more presented default value options. The method may additionally include copying the selected default value options to the case being charted. Corresponding apparatuses and computer program products are also provided.

### TECHNOLOGICAL FIELD

Embodiments of the present invention relate generally to medical computing technology and, more particularly, to methods, apparatuses, and computer program products for facilitating medical case charting.

### BACKGROUND

In modern medical practice, computers are heavily relied on to support all facets of medical practice, including, for example, patient diagnosis, the performance of medical procedures, and case documentation. In this regard, use of computing technology in medical practice has, in many cases, improved efficiency and enhanced the storage, organization, and availability of medical records and other documentation.

The use of computers is particularly prevalent for case documentation, also referred to as “charting.” Charting involves the electronic capture of information documenting the equipment, staff, and other events surrounding a medical procedure, such as a surgical procedure. In many instances, documentation of such information is regulated and required by law. While computerized charting has enhanced data capture, in many instances, charting is still an inefficient process. In this regard, charting a medical procedure may often take almost as much time, or even more time, than the time required to perform the procedure being charted.

As a result of the inefficiency of current electronic charting, efficiency and throughput at hospitals and clinics may suffer. For example, in instances wherein the time required for charting a procedure is longer than the time required for performing the procedure, resources needed for performing a subsequent procedure may be unavailable until completion of the charting. In this regard, clinicians, support personnel, equipment, operating rooms, and/or the like may be unavailable for performance of a subsequent procedure until charting of a performed procedure has been completed. As such, a start time of the subsequent procedure may be delayed. Such delays may compound over time and reduce the number of procedures that may be performed per day. Accordingly, hospitals and other medical providers may lose potential revenue due to the impact on the number of procedures that may be performed. Further, patients and insurance providers may be negatively impacted. In this regard, operating room costs are quite expensive and a bill for a procedure may be significantly increased due to additional operating room costs incurred while the procedure is charted. Additionally, if the number of procedures that may be performed is limited due to the time required for charting procedures, a patient's access to health care may be delayed while the patient waits for the availability of an operating room.

### BRIEF SUMMARY OF SOME EXAMPLES OF THE INVENTION

Methods, apparatuses, and computer program products are herein provided for facilitating medical case charting. These methods, apparatuses, and computer program products may provide several advantages to hospitals, care providers, clinicians, insurers, patients, and computing devices used in medical facilities. In this regard, some example embodiments provide for more efficient charting by automatically capturing default chart value options charted in a case. These captured default chart value options may be presented to a user as suggested chart values for a subsequent case being charted. Accordingly, redundancies in entries that may be charted across multiple cases may be leveraged to speed up case charting. Further, capture of default charting options may be automatically performed in a manner that is transparent to the user (e.g., without requiring further user action). Accordingly, a user may not be burdened with thinking ahead to determine values that may be charted in multiple cases and building default options into the system. Some example embodiments may further advantageously capture default chart value options in a manner that protects confidential patient information in compliance with applicable privacy laws.

In a first example embodiment, a method for facilitating medical case charting is provided. The method of this example embodiment may comprise causing presentation of one or more default value options for a case being charted. The default value options of this example embodiment may have been captured from data charted in one or more previously charted cases. The method of this example embodiment may further comprise determining a selection of one or more presented default value options. The method of this example embodiment may additionally comprise copying the selected default value options to the case being charted.

In another example embodiment, an apparatus for facilitating medical case charting is provided. The apparatus of this embodiment comprises at least one processor. The at least one processor may be configured to cause the apparatus of this embodiment to cause presentation of one or more default value options for a case being charted. The default value options of this example embodiment may have been captured from data charted in one or more previously charted cases. The at least one processor may be further configured to cause the apparatus of this example embodiment to determine a selection of one or more presented default value options. The at least one processor may be additionally configured to cause the apparatus of this example embodiment to copy the selected default value options to the case being charted.

In a further example embodiment, a computer program product for facilitating medical case charting is provided. The computer program product of this embodiment includes at least one non-transitory computer-readable storage medium having computer-readable program instructions stored therein. The program instructions of this example embodiment may comprise program instructions configured to cause presentation of one or more default value options for a case being charted. The default value options of this example embodiment may have been captured from data charted in one or more previously charted cases. The program instructions of this example embodiment may further comprise program instructions configured to determine a selection of one or more presented default value options. The program instructions of this example embodiment may additionally comprise program instructions configured to copy the selected default value options to the case being charted.

In yet another example embodiment, an apparatus for facilitating medical case charting is provided. The apparatus of this example embodiment may comprise means for causing presentation of one or more default value options for a case being charted. The default value options of this example embodiment may have been captured from data charted in one or more previously charted cases. The apparatus of this example embodiment may further comprise means for determining a selection of one or more presented default value options. The apparatus of this example embodiment may additionally comprise means for copying the selected default value options to the case being charted.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a charting apparatus for facilitating medical case charting according to an example embodiment;

FIG. 2 illustrates a system for facilitating medical case charting according to an example embodiment;

FIGS. 3a-3p illustrate screen captures of a workflow of an example charting session according to an example embodiment;

FIGS. 4a-4d illustrate screen captures of example default value options that may be provided for facilitating medical case charting according to an example embodiment;

FIG. 5 illustrates a flowchart according to an example method for facilitating medical case charting according to an example embodiment; and

FIG. 6 illustrates a flowchart according to an example method for capturing default value options from charted cases according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, and/or the like.

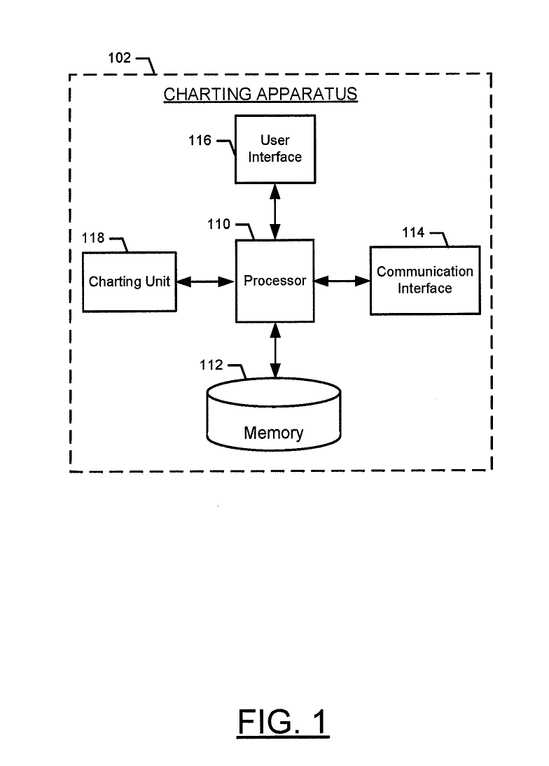

Referring now to FIG. 1, FIG. 1 illustrates a block diagram of a charting apparatus 102 for facilitating medical case charting according to an example embodiment. It will be appreciated that the charting apparatus 102 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of an apparatus for facilitating medical case charting, numerous other configurations may also be used to implement embodiments of the present invention.

The charting apparatus 102 may be embodied as any computing device or combination of a plurality of computing devices configured to facilitate medical case charting in accordance with one or more example embodiments. In this regard, by way of non-limiting example, the charting apparatus 102 may be at least partially embodied as one or more servers, a server cluster, a cloud computing infrastructure, one or more desktop computers, one or more laptop computers, one or more mobile computers (e.g., a mobile phone, tablet computing device, personal digital assistant, and/or the like), one or more network nodes, multiple computing devices in communication with each other, any combination thereof, and/or the like.

In an example embodiment the charting apparatus 102 includes various means for performing the various functions described herein. These means may include, for example, one or more of a processor 110, memory 112, communication interface 114, user interface 116, or charting unit 118 for performing the various functions herein described. The means of the charting apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

The processor 110 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 110 may comprise a plurality of processors. The plurality of processors may be embodied on a single computing device or may be distributed across a plurality of computing devices collectively configured to function as the charting apparatus 102. The plurality of processors may be in operative communication with each other and may be collectively configured to perform one or more functionalities of the charting apparatus 102 as described herein. In some embodiments, the processor 110 may be configured to execute instructions stored in the memory 112 or otherwise accessible to the processor 110. These instructions, when executed by the processor 110, may cause the charting apparatus 102 to perform one or more of the functionalities of the charting apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may include, for example, volatile and/or non-volatile memory. Although illustrated in FIG. 1 as a single memory, the memory 112 may comprise a plurality of memories. The plurality of memories may be embodied on a single computing device or distributed across a plurality of computing devices. The memory 112 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory 112 may comprise any non-transitory computer readable storage medium. The memory 112 may be configured to store information, data, applications, instructions, or the like for enabling the charting apparatus 102 to carry out various functions in accordance with example embodiments of the present invention. For example, in some example embodiments, the memory 112 is configured to buffer input data for processing by the processor 110. Additionally or alternatively, in some example embodiments, the memory 112 is configured to store program instructions for execution by the processor 110. The memory 112 may store information in the form of static and/or dynamic information. This stored information may be stored and/or used by the charting unit 118 during the course of performing its functionalities.

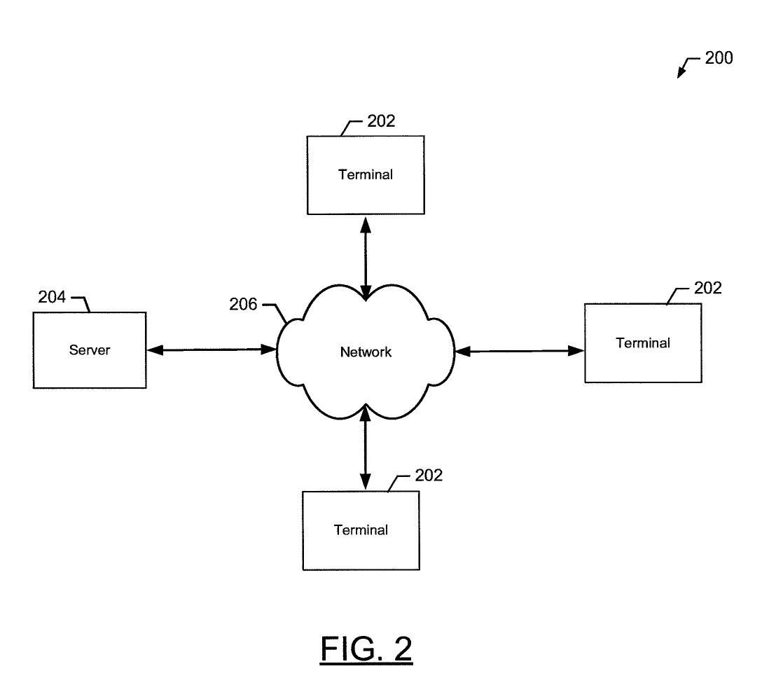

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another device, such as, for example, another charting apparatus 102, a terminal 202 (shown in FIG. 2), a server 204 (shown in FIG. 2), and/or the like. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with another computing device. The communication interface 114 may be configured to receive and/or transmit data using any protocol that may be used for communications between computing devices. As an example, the communication interface 114 may be configured to receive and/or transmit data using any protocol and/or communications technology that may be used for communicating over a network, such as the network 206 illustrated in FIG. 2. By way of example, the communication 114 may be configured to facilitate communication between a data sever 204 and one or more terminals 202, as will be described further herein below. The communication interface 114 may additionally be in communication with the memory 112, user interface 116, and/or charting unit 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In some example embodiments wherein the charting apparatus 102 is embodied as one or more servers, aspects of the user interface 116 may be more limited, or the user interface 116 may be eliminated entirely. In embodiments including a user interface 116, the user interface 116 may be in communication with the memory 112, communication interface 114, and/or charting unit 118, such as via a bus.

The charting unit 118 may be embodied as various means, such as circuitry, hardware, a computer program product comprising computer readable program instructions stored on a computer readable medium (e.g., the memory 112) and executed by a processing device (e.g., the processor 110), or some combination thereof and, in some example embodiments, is embodied as or otherwise controlled by the processor 110. In embodiments wherein the charting unit 118 is embodied separately from the processor 110, the charting unit 118 may be in communication with the processor 110. The charting unit 118 may further be in communication with one or more of the memory 112, communication interface 114, or user interface 116, such as via a bus.

Referring now to FIG. 2, FIG. 2 illustrates a block diagram of a system 200 for facilitating medical case charting according to some example embodiments. In this regard, FIG. 2 illustrates an example of a system in which the charting apparatus 102 may be implemented. In at least some embodiments, the system 200 includes one or more terminals 202 and a server 204, which may be configured to communicate over the network 206. The network 206 may comprise one or more wireless networks (e.g., a cellular network, wireless local area network, wireless metropolitan area network, and/or the like), one or more wireline networks (e.g., a wired local area network), or some combination thereof, and in some embodiments comprises at least a portion of the internet.

A terminal 202 may be embodied as any computing device by which a user may access an electronic medical charting application or other charting services, such as may be provided in accordance with an example embodiment. As non-limiting examples, a terminal 202 may comprise a desktop computer, laptop computer, an access terminal, mobile terminal, mobile computer, mobile phone, mobile communication device, tablet computing device, or the like. A terminal 202 may, for example, provide an interface for a user to access and interact with data, an application(s), service(s), and/or the like, such as may relate to medical case charting, in accordance with one or more example embodiments. Accordingly, in some example embodiments, at least some aspects of the user interface 116 may be implemented on a terminal 202. In some example embodiments, such data, application(s), service(s), and/or the like may be accessed from the server 204 via the network 206.

The server 204 may accordingly be embodied as any computing device or plurality of computing devices configured to store data, such as stored default value options, and provide access to the data to a terminal 202 via the network 206. The server 204 may additionally be configured to implement one or more applications or services for facilitating medical case charting in accordance with one or more example embodiments, which may be accessed by a terminal 202 via the network 206. By way of non-limiting example, the server 204 may be embodied as one or more servers, a server cluster, a cloud computing infrastructure, one or more desktop computers, one or more laptop computers, one or more mobile computers, one or more network nodes, multiple computing devices in communication with each other, any combination thereof, and/or the like. In some example embodiments, a data storage functionality of the server 204 may be at least partially performed by one or more of the terminals 202. In this regard, in some example embodiments, data storage (e.g., storage of default value options) may be distributed amongst the devices of the system 200.

In some example embodiments, the charting apparatus 102 may be at least partially implemented on the server 204. In such example embodiments, the terminal 202 may implement a client, such as a web client (e.g., a web browser), which may access an application, service, and/or the like that may be implemented on the server 204 to facilitate medical case charting in accordance with one or more example embodiments. Alternatively, as another example, the terminal 202 may merely store data, such as default value options captured from previous charted cases. In such example embodiments the terminal 202 may implement an application, service, and/or the like, which may facilitate medical case charting in accordance with one or more example embodiments at least in part by accessing and using data that may be stored on the server 204. Accordingly, it will be appreciated that the charting apparatus 102 may also be at least partially implemented on a terminal 202.

In view of the foregoing description, it will be appreciated that in various embodiments, the charting apparatus 102 may be implemented on a terminal 202, on a server 204, or aspects of the charting apparatus 102 may be distributed across the elements of the system 200. However, it will be appreciated that the charting apparatus 102 is not limited to embodiment in the context of the system 200, and may comprise a stand-alone computing device or plurality of computing devices, which may be implemented outside of the context of the system 200.

In some example embodiments, the charting unit 118 associated with a charting apparatus 102 may be configured to analyze a charted case and determine data values to capture from the charted case for storing as default value options, which may be provided as suggested options for charting future cases. In this regard, the charting unit 118 may identify data which may be reused in future cases. Examples of data values which may be reused in future cases may include, for example, staff names, staff roles, dressings applied, positioning devices used in a procedure, discharge defaults, supply items used in a procedure, implants, patient identification method, equipment used for a procedure, a type(s) medication used for a procedure, anesthesia type, American Society of Anesthesiologists classification, specimens taken for analysis or the like, lab tests ordered, patient transfer parameters, case discharge or outcome parameters, and/or the like. However, the charting unit 118 may determine not to capture charted patient-specific values, such as vital signs, dosages of medication, private patient data, and/or the like for future reuse.

In some example embodiments, the charting unit 118 may be configured to comply with an applicable privacy law(s) and/or regulation(s), such as the Health Insurance Portability and Accountability Act (HIPAA), when capturing data values from a charted case. In this regard, for example, the charting unit 118 may be configured to determine not to capture charted values which may not be shared or viewed without violating an applicable privacy law. As another example, the charting unit 118 may analyze a data value to be captured and remove any private patient data or other data that may be protected by a privacy law from the data value prior to saving the data value as a default value option.

The process of capturing data values as default value options may be performed automatically in a manner that may be transparent to a user. Accordingly, default value options may be captured without requiring a user to determine ahead of time what values may be reused and chart those values as defaults.

When charting a case, a user may leverage the default value options captured from a previously charted case(s) to improve efficiency in charting the case being charted. In this regard, the charting unit 118 may be configured to cause one or more default value options to be presented to a user. The default value options may be presented to the user automatically, or may be presented to the user in response to a request by the user to use a forward charting feature. The user may select from among the presented default value options, and the charting unit may copy the selected default value options to the case being charted. Accordingly, the user may be saved from having to type a value multiple times when charting multiple cases.

In some example embodiments, the charting unit 118 may be configured to automatically determine which stored default value options to present to the user as selected options. For example, the charting unit 118 may be configured to determine and suggest one or more default value options by filtering stored default value options based on at least one automatically determined filtering criterion. In this regard, the charting unit 118 may determine one or more attributes of a case being charted, such as a type of procedure which is being charted, a user (e.g., nurse or clinician) charting the case, a practitioner or doctor performing the procedure, a room (e.g., an operating room) in which the procedure is being performed, and/or the like. The charting unit 118 may use the determined attribute(s) as filtering criteria to identify stored default value options which were charted in previous cases matching the criteria. Accordingly, for example, if nurse Jane Doe is charting a case, the charting unit 118 may use “Jane Doe” as a filtering criterion to identify default value options captured from one or more cases previously charted by Jane Doe and may cause the identified default value options to be presented as options for selection in the case being charted. As another example, if a procedure being performed in Operating Room 7 is being charted, the charting unit 118 may use “Operating Room 7” as a filtering criterion to identify default value options captured from a case(s) charted for a procedure performed in Operating Room 7. As still a further example, if a myringotomy is being performed, the charting unit 118 may use “myringotomy” as a filtering criterion to identify default value options for previously charted myringotomies.

In some example embodiments, a user may manually select one or more filtering criteria. A user-selected filtering criterion may be determined by the charting unit 118, which may be used by the charting unit 118 to identify corresponding default value options in a manner similar to that described above with respect to embodiments wherein the charting unit 118 may autonomously determine a filtering criterion and suggest default value options for use in a case being charted.

In some example embodiments, data fields of a charted case which are filled using forward charting of default value options may be labeled with an audit type indicating that forward charting was used to chart the field. Accordingly, if a charted case is later audited, the procedure used to chart a particular data field may be determined.

Some example embodiments may enforce a data freshness policy with respect to stored default value options. For example, default value options which are older than (e.g., saved before or not used since) a critical date may be purged. The critical date may, for example, be a predefined time window preceding a date and/or time on which purging is performed. As an example, 30 days may be used as a critical time window, and default value options more than 30 days old may be purged.

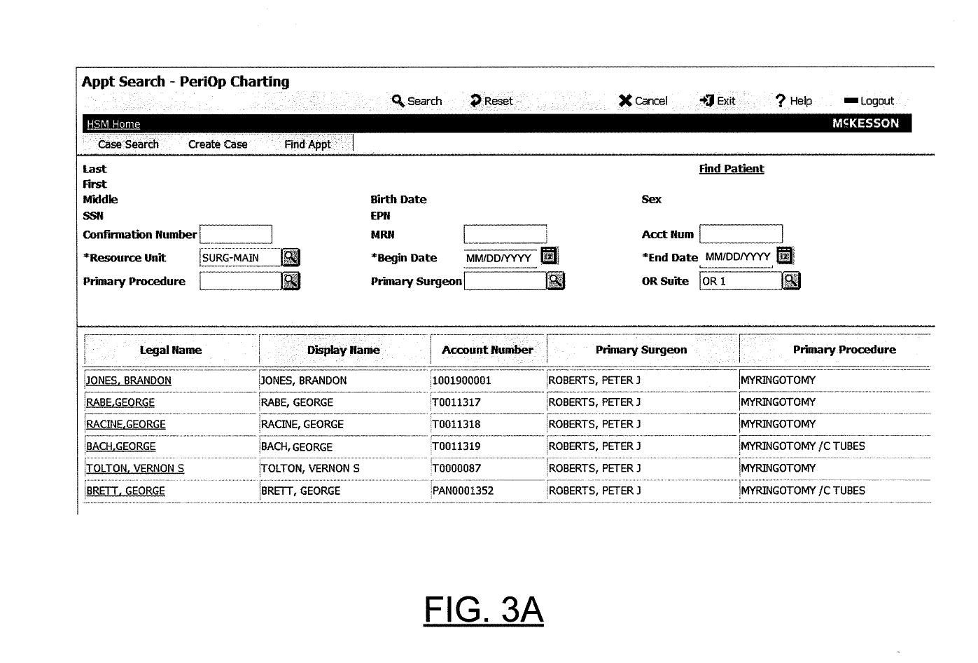

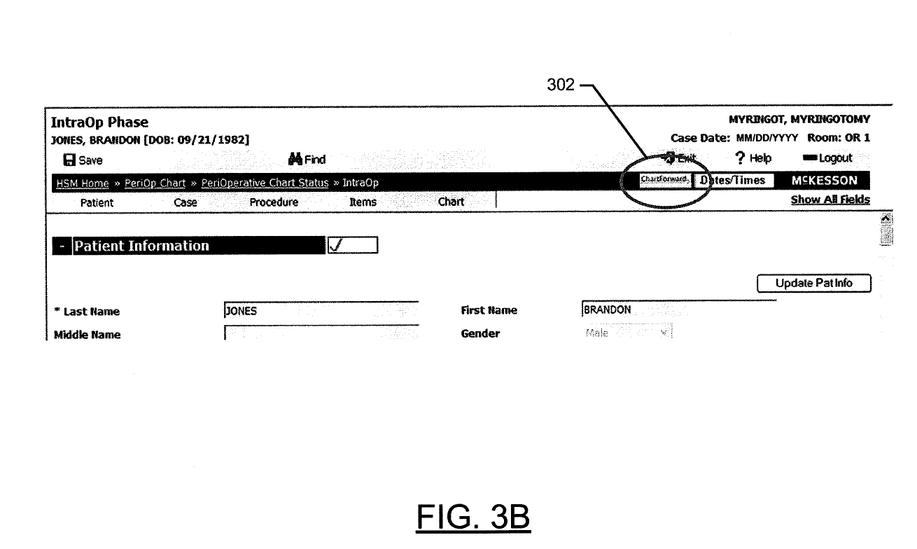

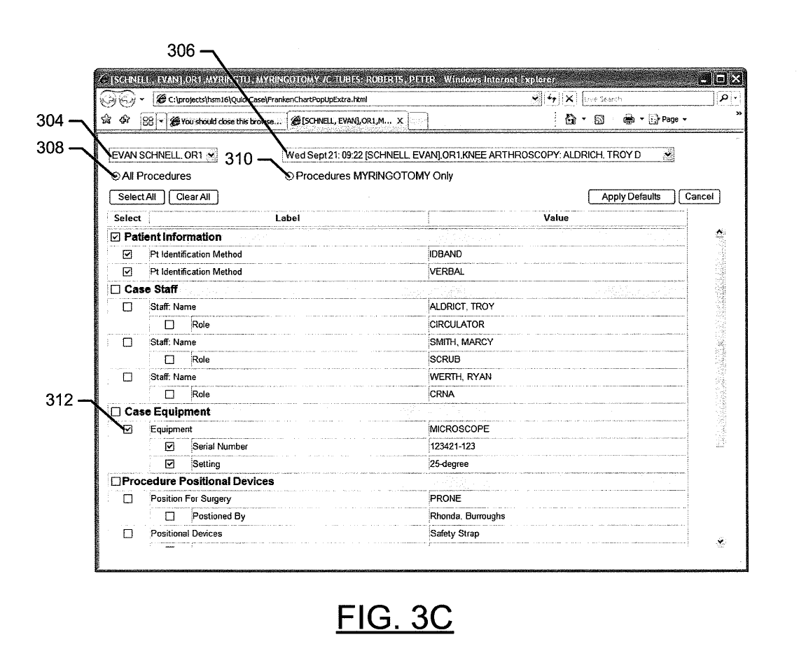

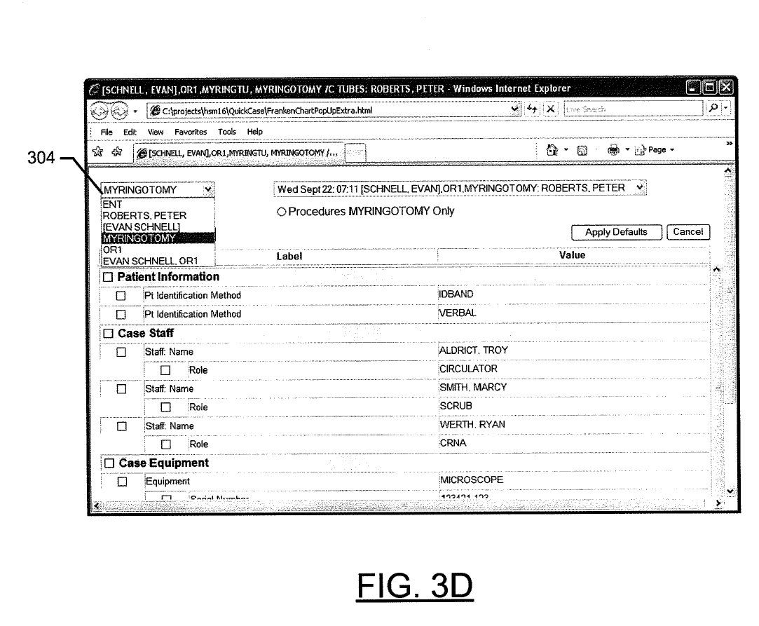

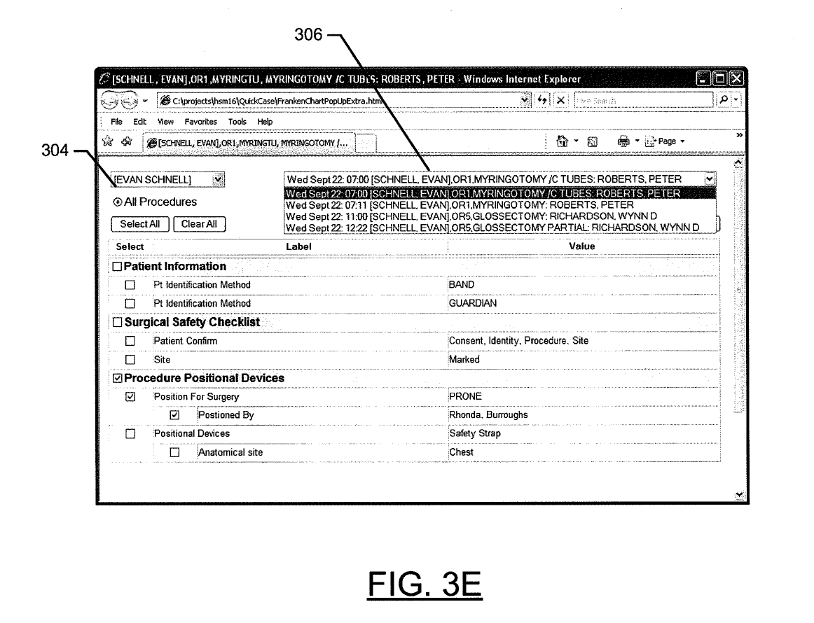

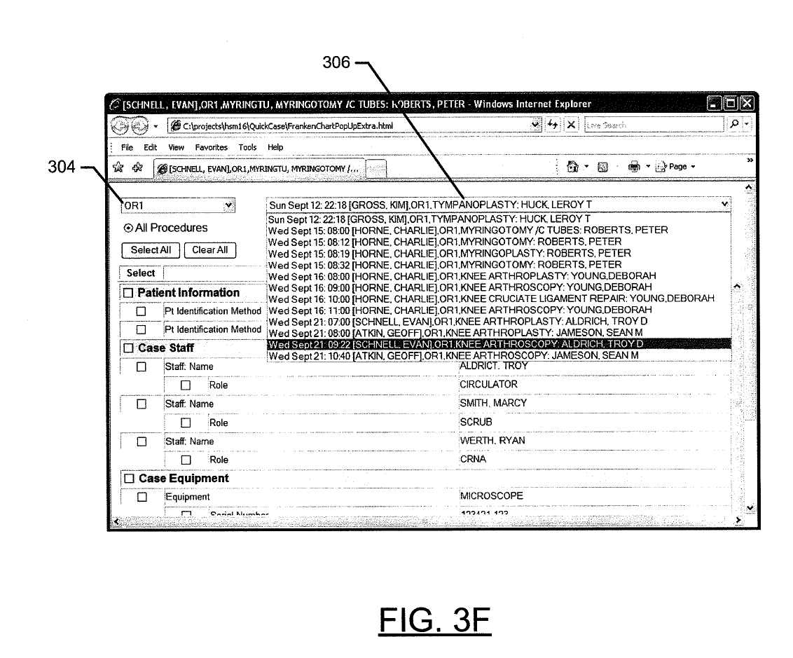

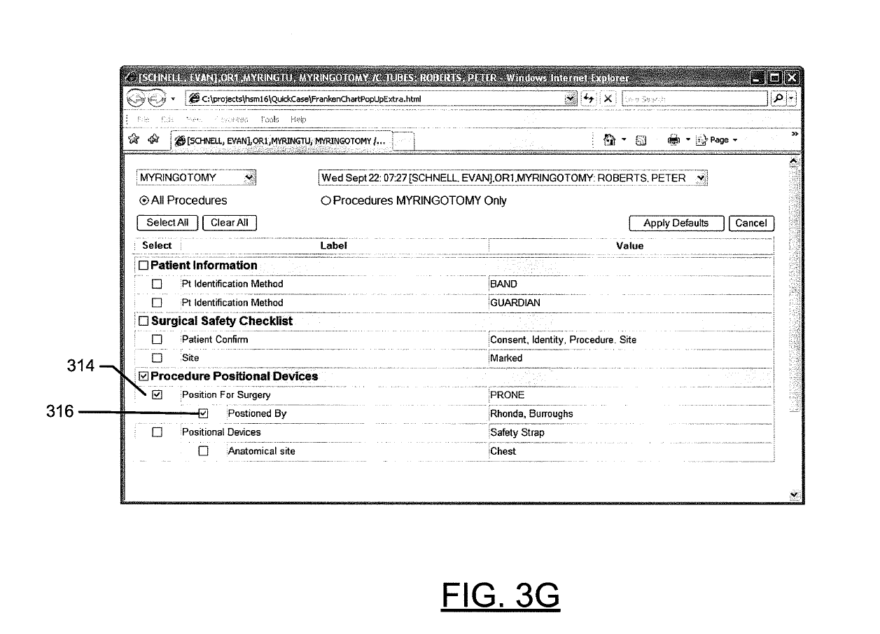

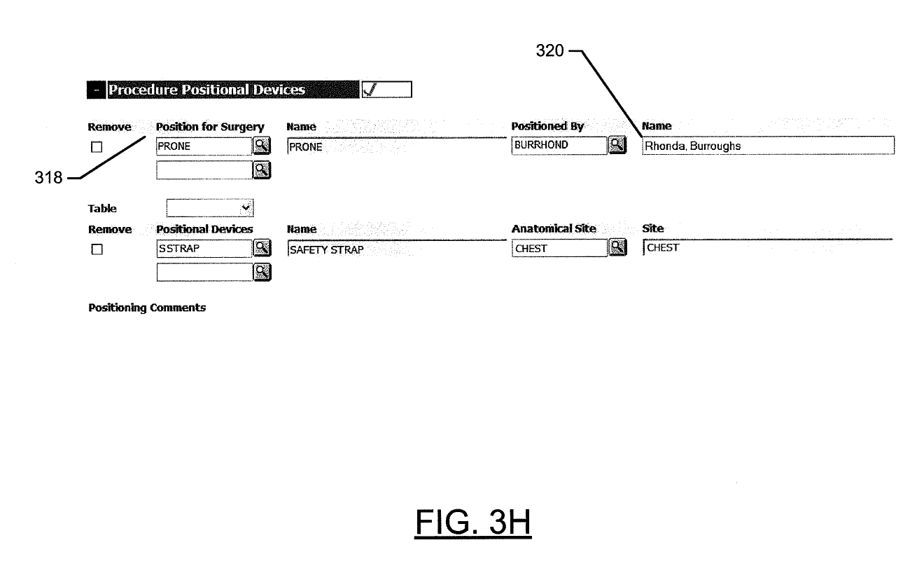

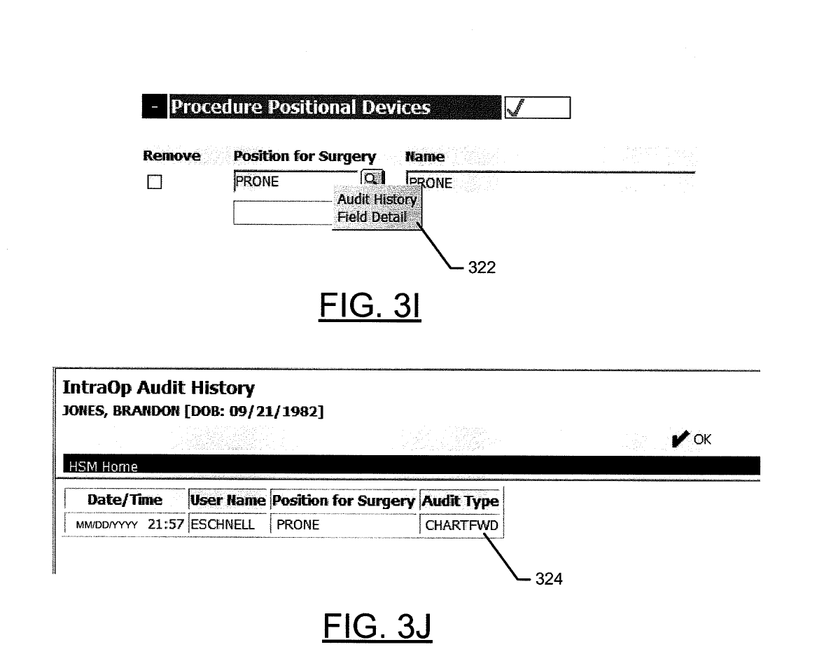

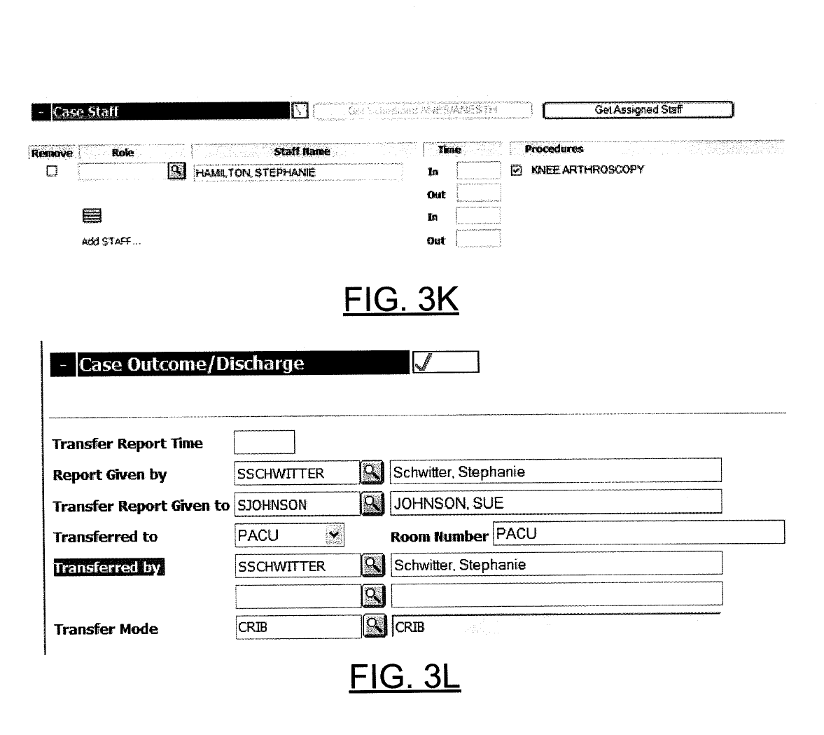

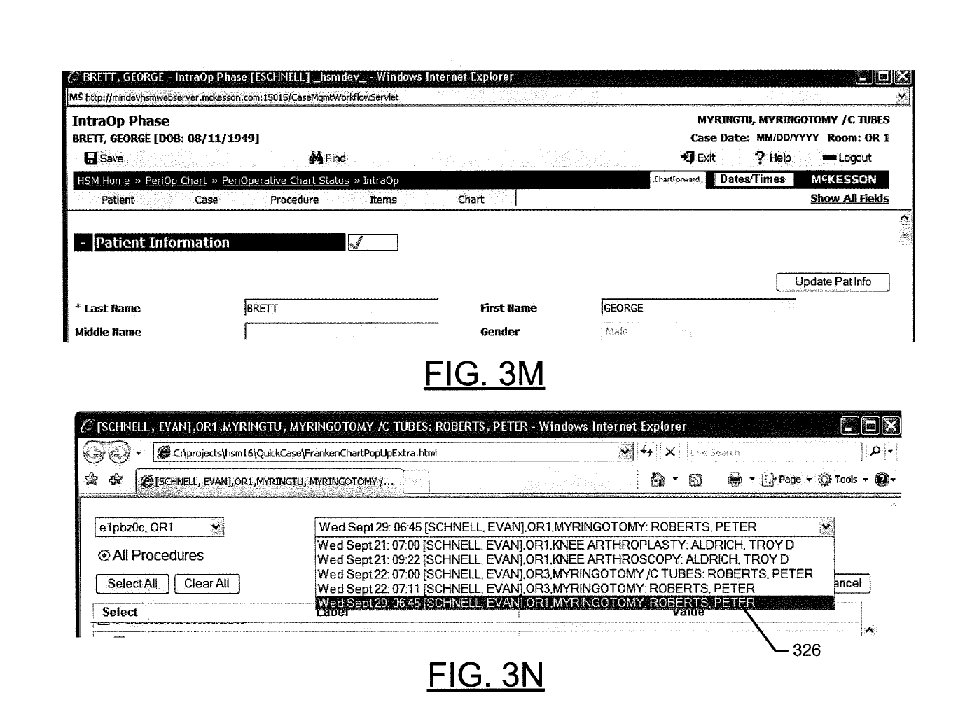

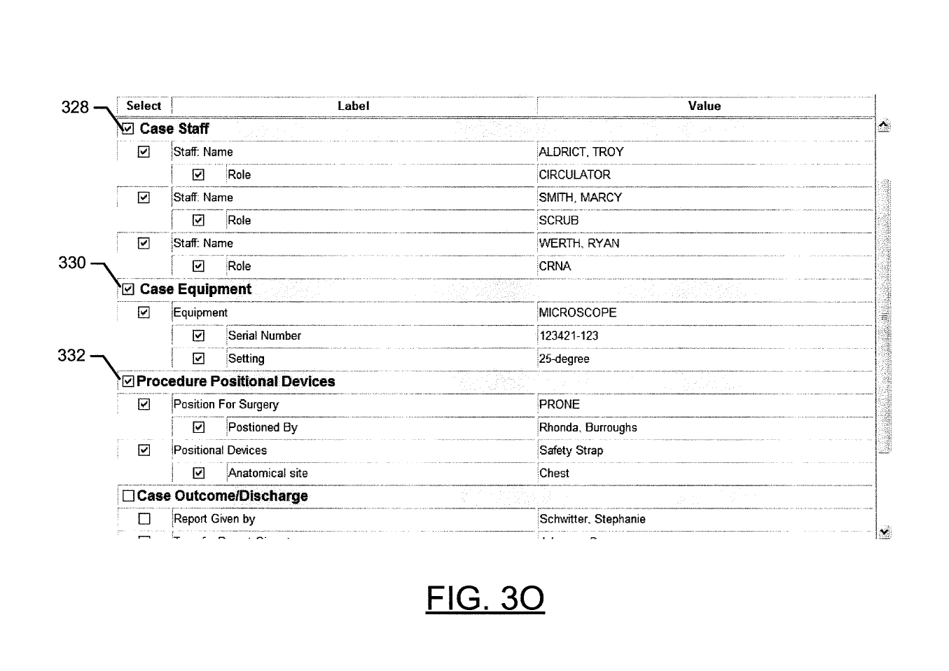

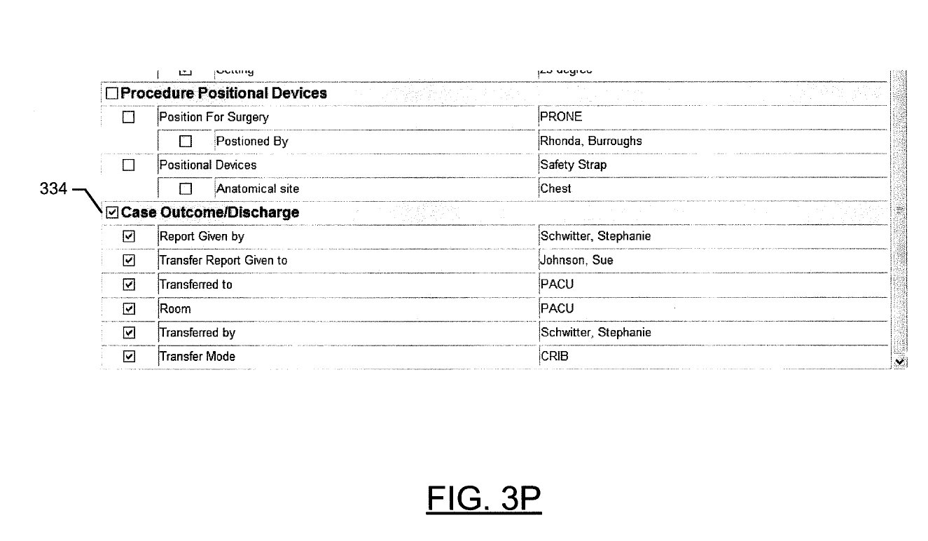

Having now generally described several example embodiments, workflow of a charting session will now be described in the context of an example embodiment illustrated in the screen captures of FIGS. 3a-3p. Referring first to FIG. 3a, an operating room schedule for Operating Room (OR) 1 is illustrated. According to the schedule, several myringotomies are to be performed. As the myringotomies are to be performed in the same operating room, several common values may be charted for all of the cases. For example, staff, procedure preparation procedures (e.g., skin preparation, hair removal), site, count type, care apparatus, care site, ancillary service, device learner, education needs, services needed, equipment, and/or the like may be common across all of the scheduled myringotomy procedures.

The user may begin to chart the first scheduled case. As this is the first case for the day, there may not be any stored default value options for the current user in OR 1 for today. The user may accordingly choose to chart the first case from scratch. However, the user may have the option to use forward charting to chart default value options that may have been captured from cases charted on a previous day. In this regard, as illustrated in FIG. 3b, after beginning to chart the first patient the user may select the “ChartForward” option 302.

Referring now to FIG. 3c, in response to selection of the ChartForward option 302, a screen may be displayed which allows the user to select one or more default value options for charting in the case being charted. The user may filter the presented default value options based on various selectable criteria. For example, a drop down box 304 may allow the user to select a filtering criterion to define a scope of previous procedures which may be available for selection from a drop down box 306. A user may select a procedure available from selection from the drop down box 306 to filter or otherwise control the default value options presented for selection.

For example, as illustrated in FIG. 3d, a user may choose from selectable filtering criteria available from the drop down box 304. The selectable filtering criteria may, for example, include a procedure (e.g., a procedure being charted), a user name, a surgeon (e.g., a surgeon performing a procedure being charted), a room (e.g., an operating room in which the procedure being charted is performed), some combination thereof, and/or the like. In the example illustrate in FIG. 3d, a user may select from “ENT” (Ear, Nose, and Throat) (e.g., a service associated with the procedure, such as ENT, orthopedics, OB/GYN, or the like), “Roberts, Peter” (e.g., the surgeon performing the procedure being charted), “Evan Schnell” (e.g., the user charting the procedure being charted), “Myringotomy” (e.g., the procedure being charted), “OR1” (e.g., the operating room in which the procedure being charted is being performed), and “Evan Schnell, OR1,” which may define the filtering criteria as a combination of the user charting the procedure being charted and the operating room in which the procedure being charted is being performed.

Referring to FIG. 3e, in response to selection of “Evan Schnell” as a filtering criterion from the drop down box 304, a set of procedures previously charted by Evan Schnell may be selectable from the drop down box 306. Accordingly, the user may select one of the procedures previously charted by Evan Schnell from the drop down box 306 as a further filtering criterion such that default value options captured from that procedure may be presented for selection. As another example, with reference to FIG. 3f, “OR1” may be selected from the drop down box 304 as a filtering criterion. In response to selection of “OR1,” charted procedures previously performed in OR1, regardless of who charted the procedures, may be selectable from the drop down box 306. Accordingly, it will be appreciated that in the example illustrated in FIGS. 3a-3p, a criterion may be selected from the drop down box 304 to filter the previously charted procedures which may be selected from the drop down box 306. Selection of a procedure from the drop down box 306 may filter the default value options presented for selection.

Referring again to FIG. 3c, the user has selected OR 1 and the procedure labeled “Wed Sept 21: 09:22 [SCHNELL, EVAN], OR1, KNEE ARTHROSCOPY: ALDRICH, TROY D” as filtering criteria to capture data values common to the operating room being used, such as staff, equipment, and the like. As illustrated in FIG. 3c default value options such as case staff (e.g., if certain staff members are assigned to an OR on a day-to-day basis) and case equipment may be selected for charting in the current case being charted. The user may select which of the options to chart, such as by selecting a box, as indicated by reference 312 wherein a user has selected the option to forward chart the microscope as equipment for the procedure.

With further reference to FIG. 3c, a user may select whether to forward chart the selected default value options to only a current procedure being charted (e.g., a myringotomy), or to all procedures for a particular surgical case. For example, selection of the “All Procedures” option 308 may forward chart the selected default value options to all procedures in the surgical case. Alternatively, selection of the “Procedures MYRINGOTOMY Only” option 310 may forward chart the selected default value options only to the myringotomy procedure being charted.

The user may then select a previously charted myringotomy to obtain default value options charted for a previous myringotomy. As illustrated in FIG. 3g, a user may choose to forward chart default value options for a position used for surgery (“PRONE”) 314 and a staff member (“Rhonda Burroughs”) 316 who positioned the patient. It will be noted that the default value options illustrated in FIGS. 3c-3g do not include any patient-sensitive data that may be protected by privacy laws, as such data may not be captured for use as a default value option in accordance with some example embodiments.

Referring now to FIG. 3h, the default value options selected in FIG. 3g may be copied to (e.g., charted in) the current case. In this regard, the selected position for surgery (“PRONE”) 318 and the name of the staff member (“Rhonda Burroughs”) 320 who positioned the patient have been copied to the current case in response to selection of the default value options presented in FIG. 3g.

As previously mentioned, fields charted using the forward charting feature may have a distinct audit type. Referring to FIG. 3i, a user may choose to audit the value of the position field, which was charted as illustrated in FIGS. 3g and 3h. In this regard, the user may, for example, right click the position field and the pop-up menu 322 may be displayed. The user may select the “Audit History” option and the audit history may be displayed as illustrated in FIG. 3j. As may be seen in FIG. 3j, the audit type for the field 324 may be listed as “CHARTFWD” to indicate that forward charting was used.

As the case being charted in the example is the first case of the day, the user may manually chart one or more staff members, as illustrated in FIG. 3k. Following completion of the procedure, the patient may be transferred to a post-anesthesia care unit (PACU). The user may log back into the charting program and chart the transfer fields for the procedure, such as transfer report time, report given by, given to, transfer to, room number, transfer by, transfer mode, and/or the like. For the first case of the day, the user may manually chart these fields, as illustrated in FIG. 3l.

The user may then open the second case of the day, as illustrated in FIG. 3m. The user may select to use forward charting for charting the second case. As the second procedure is another myringotomy being performed in the same operating room, the user may select to use the first case as a basis for forward charting. Accordingly, as illustrated in FIG. 3n, the user may select the previous case 326 as a filtering criterion for presentation of default value options. The default value options which may have been automatically captured from the previous case may be presented to the user for selection, as illustrated in FIG. 3o. The user may select to forward chart the default value options for case staff 328, case equipment 330, and procedure positional devices 332. In this regard, the user may select to forward chart values that may be known at the outset of the procedure. The selected default value options may then be copied to the second case.

After completion of the procedure, the patient may be transferred to the PACU and the user may return to chart the transfer report for the case. As at least some of the transfer values may be the same as those charted for the first case of the day, the user may select to use the chart forward feature and may again select to use the first case of the day as a basis for forward charting. As illustrated in FIG. 3p, the user may select to use the presented default value options for case outcome/discharge 334 for charting in the second case.

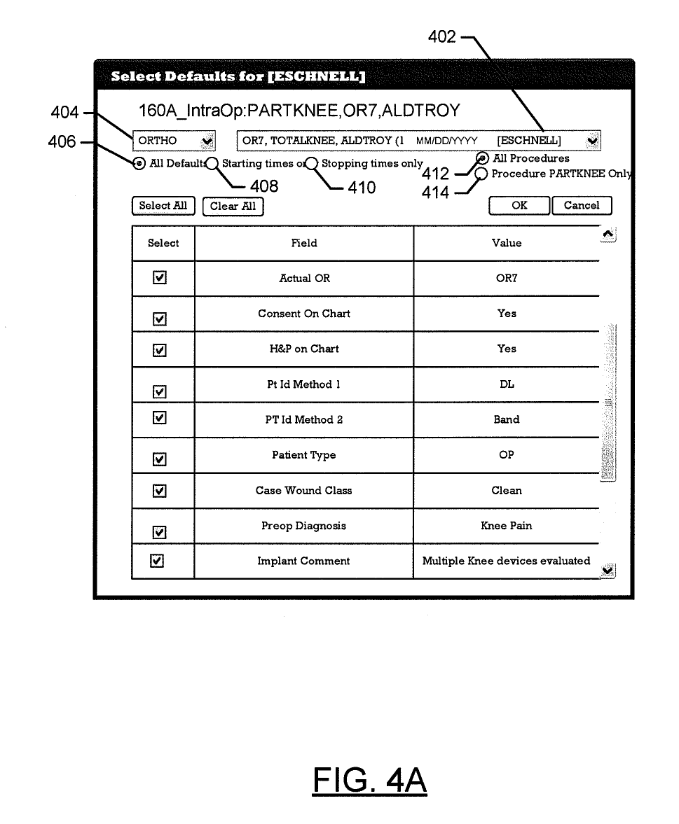

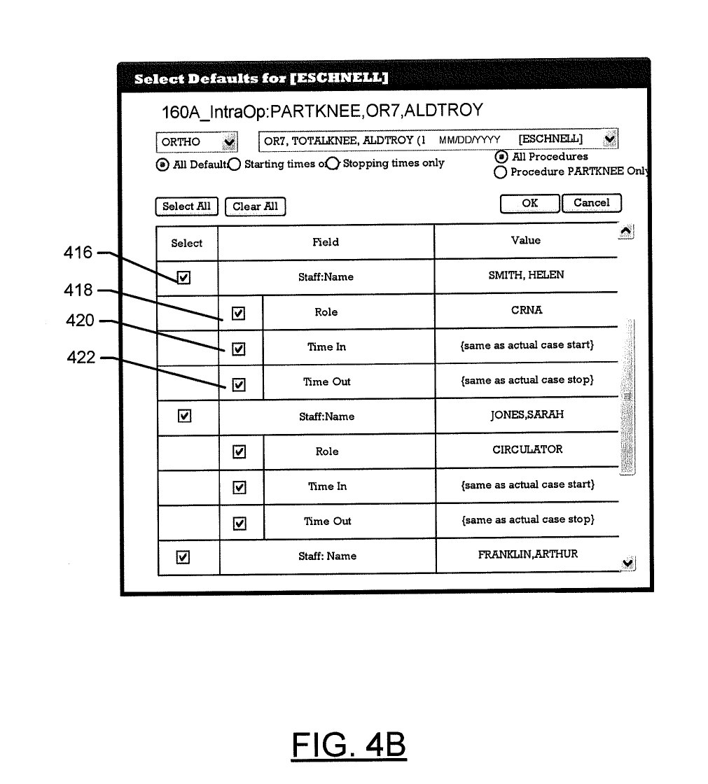

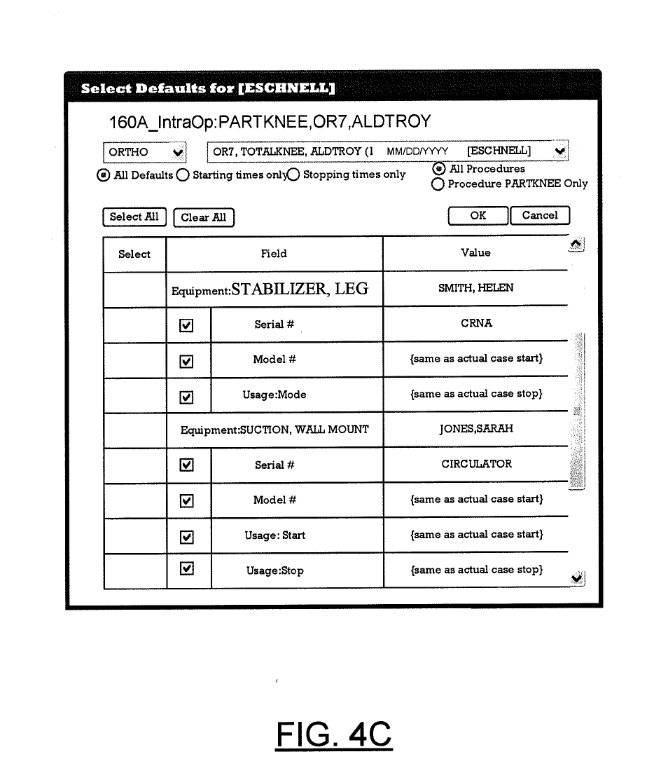

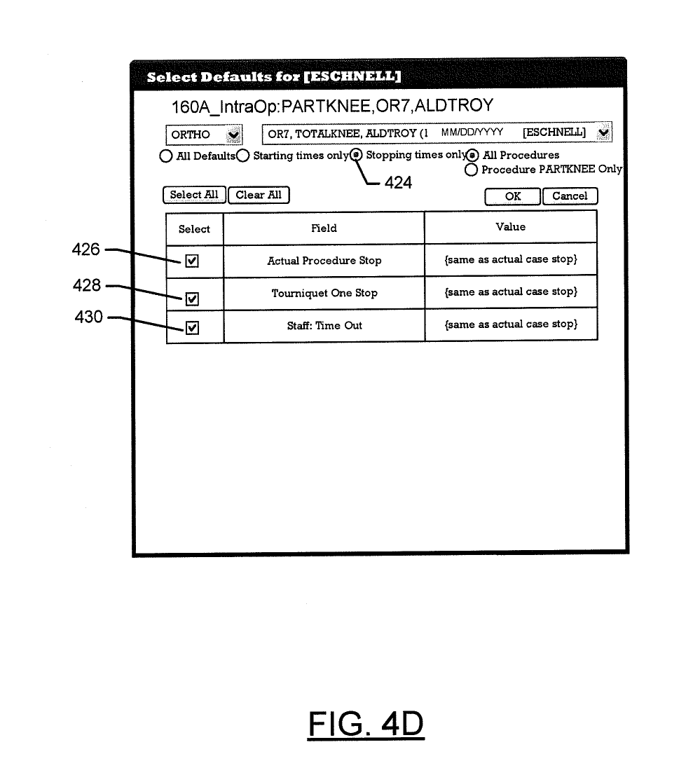

Referring now to FIGS. 4a-4d, FIGS. 4a-4d illustrate screen captures of example default value options that may be provided for facilitating medical case charting according to an example embodiment. Referring first to FIG. 4a, several selectable default value options are listed. The user may select from various filtering options to filter the presented default value options. For example, the user may select a previously performed procedure via the drop-down field 402. The filter field 404 may allow the user to filter based on a current service, current room, current user, current practitioner, and/or the like. The user may further be enabled to select the option 406 to present all default value options matching the other selected criteria, the option 408 to present only default value options for starting times, or option 410 to present only default value options for stopping times. The user may additionally select between the option 412 to forward chart selected default value options to all procedures associated with the surgical case or the option 414 to forward chart the selected default value options only to the “PARTKNEE” procedure.

As illustrated in FIG. 4b, default value options for procedure staffing may be presented. The user may select to forward chart a staff member's name (e.g., “Helen Smith”) 416 and the staff member's role (e.g., “CRNA”) 418. The user may further select to default chart the staff member's Time In 420 and Time Out 422 values. In this regard, in the example illustrated, the user has selected to default the Time In and Time Out values as the same as the times at which the case was started and the time at which the case was stopped, respectively. FIG. 4c illustrates example selectable default value options that may be presented for equipment for a procedure.

FIG. 4d illustrates an example of default charting stop times. As illustrated, the user has selected the option 424 to display only default value options for stopping times. The user may select among the presented default value options to chart the actual procedure stop time 426, the tourniquet one stop time 428, and/or the staff's time out 430 the same as the actual case stop time.

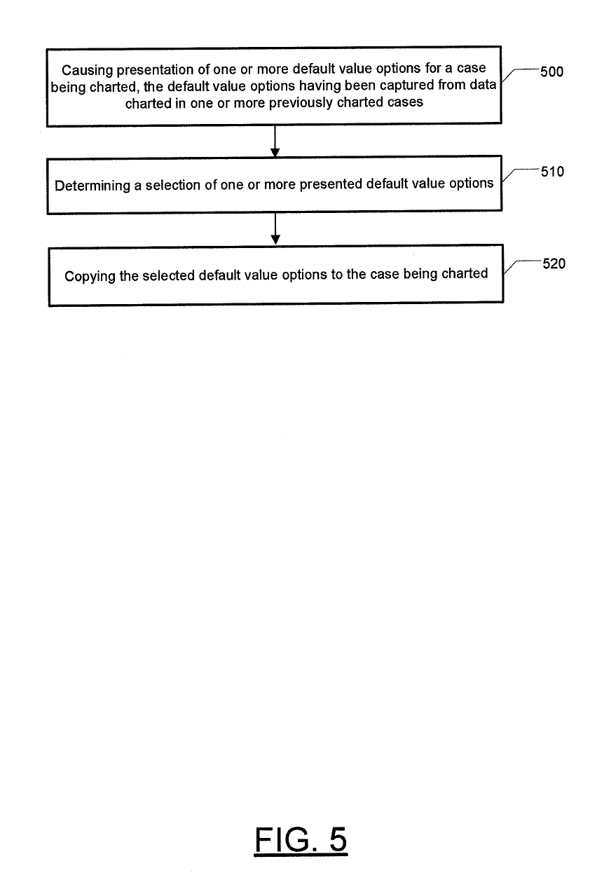

Referring now to FIG. 5, FIG. 5 illustrates a flowchart according to an example method for facilitating medical case charting according to an example embodiment. In this regard, FIG. 5 illustrates a method that may be performed at a charting apparatus 102. The operations illustrated in and described with respect to FIG. 5 may, for example, be performed by, with the assistance of, and/or under the control of one or more of the processor 110, memory 112, communication interface 114, user interface 116, or charting unit 118. Operation 500 may comprise causing presentation of one or more default value options for a case being charted. The default value options may have been captured from data charted in one or more previously charted cases. Operation 510 may comprise determining a selection of one or more presented default value options. Operation 520 may comprise copying the selected default value options to the case being charted.

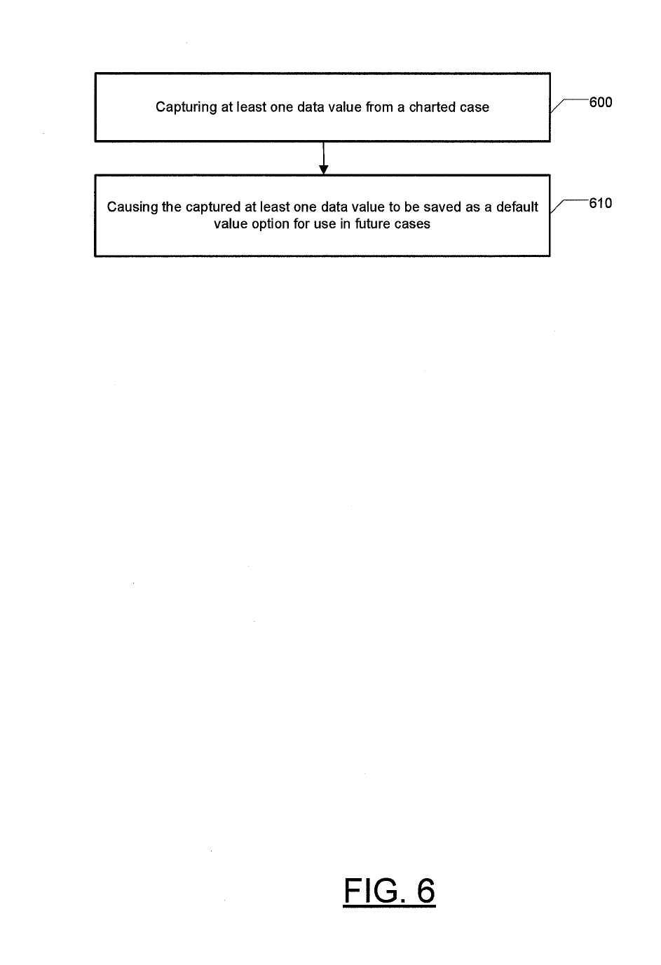

FIG. 6 illustrates a flowchart according to an example method for capturing default value options from charted cases according to an example embodiment. In this regard, FIG. 6 illustrates a method that may be performed at a charting apparatus 102. The operations illustrated in and described with respect to FIG. 6 may, for example, be performed by, with the assistance of, and/or under the control of one or more of the processor 110, memory 112, communication interface 114, user interface 116, or charting unit 118. Operation 600 may comprise capturing at least one data value from a charted case. Operation 610 may comprise causing the captured at least one data value to be saved as a default value option for use in future cases.

FIGS. 5-6 each illustrate a flowchart of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device (e.g., a charting apparatus 102, terminal 202, server 204, or combination thereof) and executed by a processor (e.g., the processor 110) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for facilitating medical case charting, the method comprising:
causing presentation of one or more default value options for a case being charted, the default value options having been captured from data charted in one or more previously charted cases;
determining, by a processor, a selection of one or more presented default value options; and
copying the selected default value options to the case being charted.

2. The method of claim 1, further comprising:
determining a filtering criterion; and
determining one or more default value options satisfying the filtering criterion;
wherein causing presentation of one or more default value options comprises causing presentation of the one or more default value options determined to satisfy the filtering criterion.

3. The method of claim 2, wherein the filtering criterion comprises one or more of a current user, a practitioner, a room, a service, a procedure, or a previously charted case.

4. The method of claim 1, further comprising:
determining a selection of a first filtering criterion;
determining at least one previously charted case satisfying the first filtering criterion;
causing the determined at least one previously charted case to be presented for selection;
determining a selection of a second filtering criterion, the second filtering criterion comprising a selected previously charted case;
determining one or more default value options captured from the selected previously charted case; and
wherein causing presentation of one or more default value options comprises causing presentation of the determined one or more default value options.

5. The method of claim 4, wherein the first filtering criterion comprises one or more of a current user, a practitioner, a room, a service, or a procedure.

6. The method of claim 1, wherein the presented default value options do not comprise any private patient data from the one or more previously charted cases.

7. The method of claim 1, wherein the default value options were automatically captured from data charted in one or more previously charted cases.

8. The method of claim 1, further comprising:
capturing at least one data value from a charted case; and
causing the captured at least one data value to be saved as a default value option.

9. The method of claim 8, wherein capturing the at least one data value comprises, for a data value to be captured:
analyzing the data value to be captured to identify any private patient data in the data value to be captured; and
removing any identified private patient data from the data value to be captured prior to saving the data value to be captured as a default value option.

10. The method of claim 9, wherein analyzing the data value to be captured comprises analyzing the data value to be captured to identify any data protected by a patient privacy law.

11. The method of claim 1, further comprising, for a field charted with a selected default value option, labeling the field with an audit type, the audit type indicating that forward charting was used to chart the field.

12. The method of claim 1, further comprising purging stored default value options in accordance with a data freshness policy.

13. An apparatus for facilitating medical case charting, the apparatus comprising at least one processor, wherein the at least one processor is configured to cause the apparatus to at least:
cause presentation of one or more default value options for a case being charted, the default value options having been captured from data charted in one or more previously charted cases;
determine a selection of one or more presented default value options; and
copy the selected default value options to the case being charted.

14. The apparatus of claim 13, wherein the at least one processor is configured to further cause the apparatus to:
determine a filtering criterion;
determine one or more default value options satisfying the filtering criterion; and
cause presentation of one or more default value options by causing presentation of the one or more default value options determined to satisfy the filtering criterion.

15. The apparatus of claim 14, wherein the filtering criterion comprises one or more of a current user, a practitioner, a room, a service, or a procedure.

16. The apparatus of claim 13, wherein the at least one processor is configured to further cause the apparatus to:
determine a selection of a first filtering criterion;
determine at least one previously charted case satisfying the first filtering criterion;
cause the determined at least one previously charted case to be presented for selection;
determine a selection of a second filtering criterion, the second filtering criterion comprising a selected previously charted case;
determine one or more default value options captured from the selected previously charted case; and
wherein the at least one processor is configured to cause the apparatus to cause presentation of one or more default value options at least in part by causing presentation of the determined one or more default value options.

17. The apparatus of claim 13, wherein the presented default value options do not comprise any private patient data from the one or more previously charted cases.

18. The apparatus of claim 13, wherein the at least one processor is configured to further cause the apparatus to:
capture at least one data value from a charted case; and
cause the captured at least one data value to be saved as a default value option.

19. The apparatus of claim 18, wherein the at least one processor is configured to cause the apparatus to capture the at least one data value at least in part by, for a data value to be captured:
analyzing the data value to be captured to identify any private patient data in the data value to be captured; and
removing any identified private patient data from the data value to be captured prior to saving the data value to be captured as a default value option.

20. The apparatus of claim 19, wherein analyzing the data value to be captured comprises analyzing the data value to be captured to identify any data protected by a patient privacy law.

21. The apparatus of claim 13, wherein the at least one processor is configured to further cause the apparatus, for a field charted with a selected default value option, to label the field with an audit type, the audit type indicating that forward charting was used to chart the field.

22. The apparatus of claim 13, further comprising at least one memory storing instructions that when executed by the at least one processor cause the apparatus to:
cause presentation of one or more default value options for a case being charted, the default value options having been captured from data charted in one or more previously charted cases;
determine a selection of one or more presented default value options; and
copy the selected default value options to the case being charted.

23. A computer program product for facilitating medical case charting, the computer program product comprising at least one non-transitory computer-readable storage medium having computer-readable program instructions stored therein, the computer-readable program instructions comprising:
program instructions configured to cause presentation of one or more default value options for a case being charted, the default value options having been captured from data charted in one or more previously charted cases;
program instructions configured to determine a selection of one or more presented default value options; and
program instructions configured to copy the selected default value options to the case being charted.
